(19) United States
(12) Patent Application Publication
(10) Pub. No.: US 2021/0156343 A1
(43) Pub. Date: May 27, 2021

(54) CONTROL DEVICE FOR AN INTERNAL COMBUSTION ENGINE

(71) Applicant: PIERBURG GMBH, NEUSS (DE)

(72) Inventor: HOLGER PAFFRATH, PULHEIM (DE)

(73) Assignee: PIERBURG GMBH, NEUSS (DE)

(21) Appl. No.: 16/612,402

(22) PCT Filed: Apr. 20, 2018
(86) PCT No.: PCT/EP2018/060173

§ 371 Date: Nov. 11, 2019

(30) Foreign Application Priority Data
May 12, 2017 (DE) 10 2017 110 324.4

(51) Int. Cl. F02M 26/21; F02M 26/70

(52) U.S. Cl. CPC F02M 26/21; F02M 26/54; F02M 26/70

(57) ABSTRACT

A control device for an internal combustion engine includes an air intake channel, an exhaust gas recirculation channel which enters into the air intake channel, a valve seat formed at an opening at an end of the exhaust gas recirculation channel, and an elastic valve disk which is placeable on the valve seat via an actuator so that the opening of the exhaust gas recirculation channel can be closed. A plane spanned by the valve seat and/or by the valve disk forms an at least single-curved concave surface.

### CROSS REFERENCE TO PRIOR APPLICATIONS

This application is a U.S. National Phase application under 35 U.S.C. § 371 of International Application No. PCT/EP2018/060173, filed on Apr. 20, 2018 and which claims benefit to German Patent Application No. 10 2017 110 324.4, filed on May 12, 2017. The International Application was published in German on Nov. 15, 2018 as WO 2018/206268 A1 under PCT Article 21(2).

### FIELD

The present invention relates to a control device for an internal combustion engine, comprising an exhaust gas recirculation channel, an air intake channel into which the exhaust gas recirculation channel enters, a valve seat formed at an opening at the end of the exhaust gas recirculation channel, and a valve disk that can be placed on the valve seat via an actuator so that the opening of the exhaust gas recirculation channel can be closed.

### BACKGROUND

Control devices have previously been described and serve to control recirculated exhaust gas. In order to reduce pollutants, the exhaust gas of the internal combustion engine is recirculated to the internal combustion engine by opening a control element via an exhaust gas recirculation channel. Re-combustion in the internal combustion engine reduces the nitrogen oxide concentration of the recirculated exhaust gas so that the total pollutant emissions are reduced.

It is known that condensate can be produced in the air intake channel which may cause damage, for example, to the compressor.

DE 10 2014 200 699 A1 describes a control device for an internal combustion engine which comprises an exhaust gas recirculation flap which opens or closes an exhaust gas recirculation channel entering into an air intake channel. An area between the air intake channel and the exhaust gas recirculation channel is formed so that condensate produced in the air intake channel can be discharged to the exhaust gas recirculation channel after lifting the exhaust gas recirculation flap from the valve seat.

In previously described control devices, the exhaust gas recirculation flap closes the exhaust gas recirculation channel in a resting position so that condensate produced after the internal combustion engine has been stopped cannot flow off into the exhaust gas recirculation channel, but accumulates on the flap. The condensation water can freeze in the area of the valve seat at low temperatures and longer standing times of the internal combustion engine so that it is not possible to open the flap at the beginning of the warm-up phase. The flap can only be opened if the exhaust gas has thawed the ice at the control element. It is thus not possible to reduce the pollutant emission immediately after a cold start. Condensate can also be produced when stopping and thus cooling down the combustion engine at higher temperatures, which is then supplied to the compressor when restarting the combustion engine where it may cause damage.

There is also a constant interest in further reducing emissions to meet the high requirements concerning exhaust gas emissions.

### SUMMARY

An aspect of the present invention is to provide a control device for an internal combustion engine which has a lower freezing risk of the control device, which prevents damage to the compressor, and which allows for a further reduction of exhaust gas emissions.

In an embodiment, the present invention provides a control device for an internal combustion engine which includes an air intake channel, an exhaust gas recirculation channel which is arranged to enter into the air intake channel, a valve seat formed at an opening at an end of the exhaust gas recirculation channel, and a valve disk which is configured to be placed on the valve seat via an actuator so that the opening of the exhaust gas recirculation channel can be closed. The valve disk is elastic. A plane spanned by at least one of the valve seat and by the valve disk forms an at least single-curved concave surface.

### BRIEF DESCRIPTION OF THE DRAWINGS

The present invention is described in greater detail below on the basis of embodiments and of the drawings in which:

FIG. 1 shows a control device for an internal combustion engine in a resting position according to a first exemplary embodiment of the present invention;

FIG. 2 shows a control device according to FIG. 1 in a closed position;

FIG. 3 shows a control device for an internal combustion engine in a resting position according to a second exemplary embodiment of the present invention; and

FIG. 4 shows the control device according to FIG. 3 in a closed position.

### DETAILED DESCRIPTION

In the control device according to the present invention, a plane spanned by the valve seat and/or the valve disk forms an at least single-curved concave surface. With a single-curved surface, each tangent plane of the surface contacts the surface along an entire surface curve. According to the present invention, an at least single-curved concave surface also comprises a double-curved concave surface. With a double-curved surface, each tangent plane of the surface correspondingly contacts the surface locally in exactly one point. The curvature directions of the double-curved surface can, for example, be orthogonal to each other. The concave shape of the surfaces is provided at least in a resting position of the control device and is determined in relation to an intermediate area between the valve seat and the valve disk.

When the valve disk rests on the valve seat in the resting position, i.e., without an active force applied by the actuator, at least one gap is formed between the valve disk and the valve seat through which condensate can drain after stopping the internal combustion engine. This significantly reduces the risk of freezing. The control device is thus ready for operation immediately after a cold start. This makes it possible to reduce pollutant emissions immediately after the cold start, thereby further reducing emissions. The condensate which has been discharged to the exhaust gas recirculation channel is also evaporated by the warm exhaust gas during a restart and is therefore not conducted in liquid form to the compressor, thereby avoiding damage to the compressor.

The valve disk is elastic according to the present invention. During operation, the control device can therefore also assume positions in which no exhaust gas is recirculated from the exhaust gas recirculation channel. The valve disk bends in a direction along an exhaust gas recirculation channel axis. By moving the control device into a closed position via an actively applied force of the actuator, the valve disk bends so that it adapts to the shape of the valve seat and rests thereon in a circumferential sealing manner.

Between the positions in which the valve disk rests on the valve seat in a sealing manner and in which the valve disk barely contacts the valve seat, the exhaust gas is only recirculated through the gaps formed between the valve seat and the valve disk. The recirculated exhaust gas quantity can be very precisely controlled between these positions, thereby optimally adapting the recirculated exhaust gas quantity to the reduction of emissions. A further reduction in emissions can thereby be achieved.

In an embodiment of the present invention, a curvature of the single-curved concave surface can, for example, run parallel to an air intake channel central axis. The gaps formed between the valve seat and the valve disk are thus located in a direction orthogonal to a main flow direction of the air intake channel. The gaps are thus not located in the flow of the air intake channel so that a backflow of air from the air intake channel into the exhaust gas recirculation channel can be avoided. The recirculated exhaust gas can thus be introduced more easily into the air intake channel.

In an embodiment of the present invention, a curvature of the single-curved concave surface can, for example, run orthogonal to an air intake channel central axis. The gaps formed between the valve seat and the valve disk are thus located in a main flow direction of the air intake channel, so that the condensate flowing back from the compressor is returned to the exhaust gas recirculation channel via the shortest route.

In an embodiment of the present invention, the spanned plane can, for example, form a double-curved concave surface. Each tangent plane of the surface contacts the surface locally in exactly one point with a double-curved concave surface. The curvature directions of the double-curved surface can, for example, be orthogonal to each other. Due to the double-curved concave surface, the number of gaps can be increased so that the condensate can be discharged even more effectively.

In an embodiment of the present invention, the valve disk can, for example, be arranged in the air intake channel so that the valve disk is pivotable about a pivot axis. The pivot axis is arranged orthogonally to the air intake channel central axis. It is thus possible, when opening the exhaust gas recirculation channel, to throttle the air intake channel, thereby increasing the pressure difference and thus increasing the exhaust gas mass flow.

The valve disk is alternatively arranged in the air intake channel along an exhaust gas recirculation axis. The valve disk is thus moved in its axial direction.

It is advantageous if the valve disk is made of sheet metal. Sheet metal is a cost-effective material which has the required elasticity and is also simple to process. This makes it possible to manufacture the control device more economically.

In an embodiment of the present invention, the control device can, for example, be spring-loaded so that the valve disk rests on the valve seat in a resting position of the control device in which the actuator is not activated, wherein a spring force of the valve disk is dimensioned so that at least one gap is formed between the valve disk and the valve seat in this position. The result of this embodiment is that no sealing connection exists in a resting position of the control device, so that the condensate can drain into the exhaust gas recirculation channel through gaps between the valve disk and the valve seat. This prevents the control device from freezing.

It is particularly advantageous if, in a closed position of the control device, the valve disk is pressed sealingly against the spring force by the actuator onto the valve seat. A sealing position of the valve is thus only possible if the actuator actively presses the valve disk against the spring force of the valve disk onto the valve seat.

It is thereby provided that gaps are formed between the valve disk and the valve seat in a resting position of the control so that the condensate can drain and a freezing of the control device as well as damage to the compressor can be avoided.

A control device for an internal combustion engine is thus provided which has a lower risk concerning the freezing of the control device. The control device also makes it possible to further reduce exhaust gas emissions and to avoid damage to the compressor by actively supplying liquid water.

Further details and advantages of the present invention result from the following description of the exemplary embodiments in conjunction with the drawings.

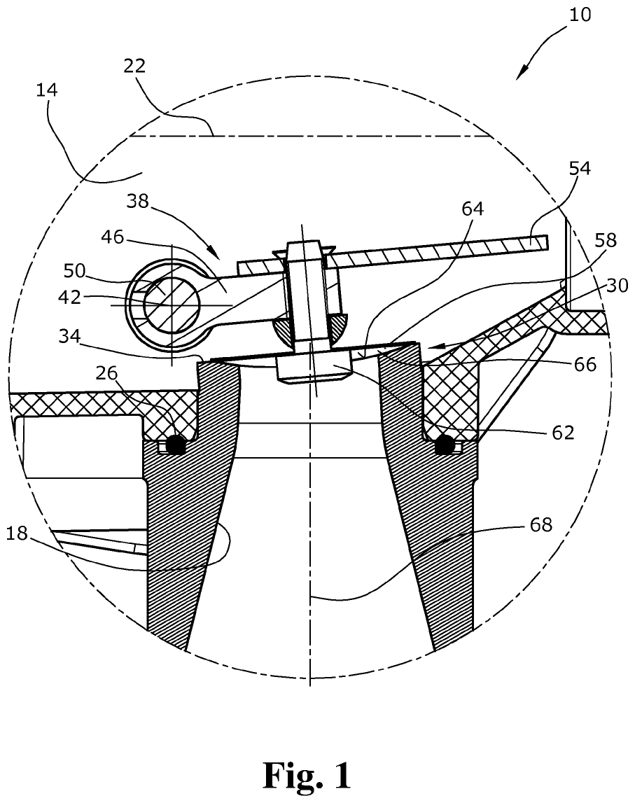

FIG. 1 shows a control device 10 for an internal combustion engine according to a first exemplary embodiment of the present invention. Control device 10 comprises an air intake channel 14 through which air is conducted to an internal combustion engine and an exhaust gas recirculation channel 18 which, orthogonally to an air intake channel central axis 22, enters into air intake channel 14 and through which exhaust gas can be recirculated into air intake channel 14. Exhaust gas recirculation channel 18 is sealed against air intake channel 14 via a seal 26.

A valve seat 34 is formed at an opening 30 at the end of the exhaust gas recirculation channel 18. A control element 38 is arranged in air intake channel 14 via which a recirculated exhaust gas flow from exhaust gas recirculation channel 18 can be controlled. Control element 38 can be pivoted by an actuator (which is not shown in the drawings) about a pivot axis 42 provided orthogonally to air intake channel central axis 22. Control element 38 is formed by a pivot arm 46, which is connected to a pivot shaft 50, a throttle flap 54, which throttles an air flow in air intake channel 14, and a valve disk 58, with which the opening 30 of exhaust gas recirculation channel 18 can be closed. Throttle flap 54 and valve disk 58 are mounted on pivot arm 46 via a common screw 62.

FIG. 1 shows control device 10 in a resting position which is set, for example, after the internal combustion engine is stopped. In this position, a spring (which is not shown in the drawings) in the actuator pushes pivot arm 46 together with valve disk 58 in the direction of valve seat 34 so that valve disk 58 rests on valve seat 34. FIG. 1 shows that valve seat 34 forms a single-curved concave surface 64 whose curvature direction is parallel to air intake channel central axis 22, so that gaps 66 are formed in the resting position between valve disk 58 and valve seat 34 at sides orthogonal to air intake channel central axis 22. Valve disk 58 thus rests only on areas of valve seat 34 whose radial direction is parallel to air intake channel central axis 22. Condensate can be discharged through the gaps 66 in the resting position of control device 10 so that a freezing of control device 10 is avoided.

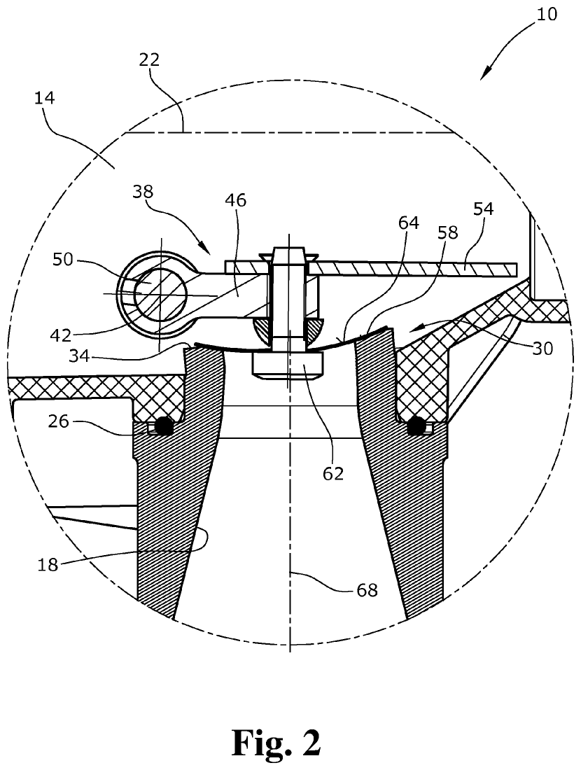

FIG. 2 shows control device 10 from FIG. 1 in a closed position. In this position, the actuator applies a torque to control element 38 against a spring force of valve disk 58, so that valve disk 58 bends elastically along an exhaust gas recirculation channel axis 68 and rests sealingly against the single-curved concave surface 64 of valve seat 34.

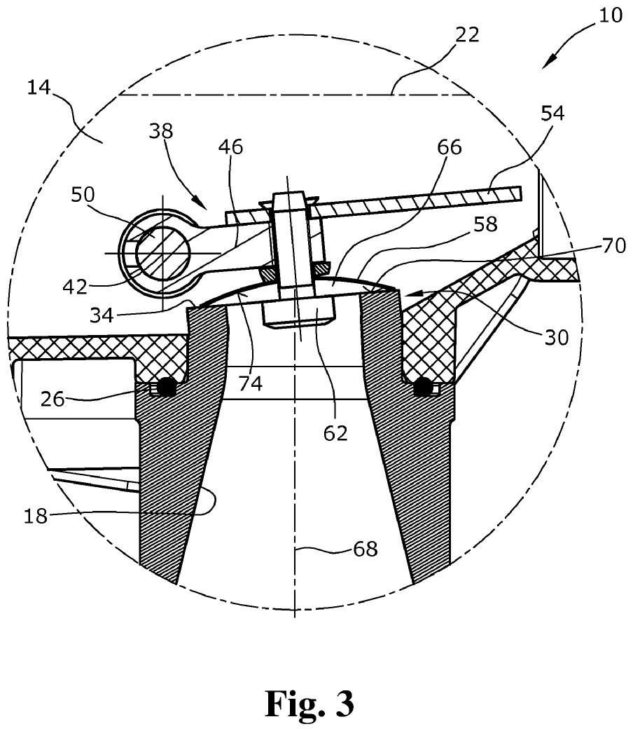

FIG. 3 shows a second exemplary embodiment of control device 10 in a resting position according to the present invention. The second exemplary embodiment differs from the first exemplary embodiment in FIG. 1 in that valve seat 34 spans an even surface 70 and valve disk 58 forms a single-curved concave surface 74. The curvature direction of the single-curved concave surface 74 is parallel to air intake channel central axis 22, so that gaps 66 are formed in the resting position between valve disk 58 and valve seat 34 at sides orthogonal to air intake channel central axis 22. Valve disk 58 thus rests only on areas of valve seat 34 whose radial direction is parallel to air intake channel central axis 22. Condensate can be discharged through the gaps 66 in the resting position of control device 10 so that a freezing of control device 10 is avoided.

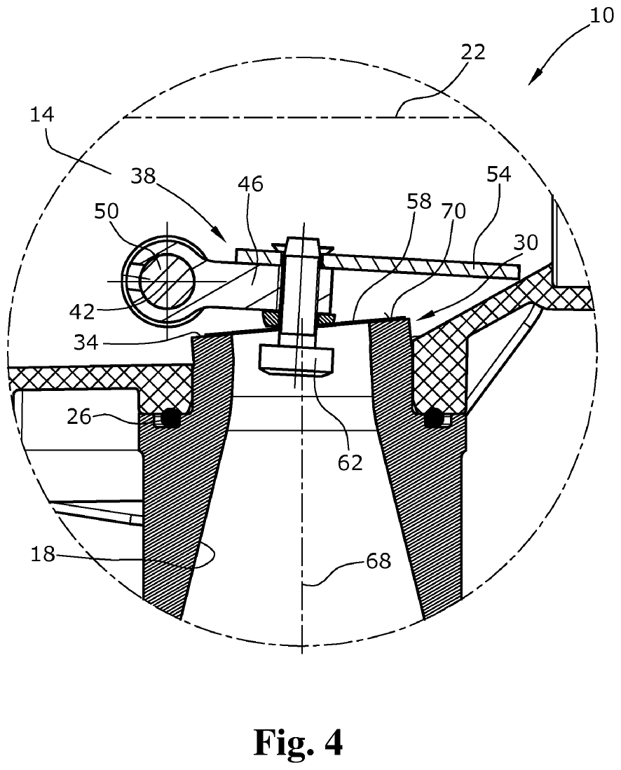

FIG. 4 shows control device 10 from FIG. 3 in a closed position. In this position, the actuator applies a torque to control element 38 against a spring force of valve disk 58, so that valve disk 58 bends elastically along an exhaust gas recirculation channel axis 68 and rests sealingly against even valve seat 34.

The described device according to the present invention thus has a lower risk concerning the freezing of the control device. It is also possible to further reduce exhaust gas emissions due to an improved controllability of the control element. Damage to the compressor due to supplied liquid water, in particular after restarting the internal combustion engine, are reliably avoided.

It should be clear that the scope of protection of the present invention is not limited to the described exemplary embodiments of a control device, but that various modifications and constructive changes are possible. Embodiments are, for example, possible in which both the valve seat and the valve disk comprise a single-curved concave surface. Reference should also be had to the appended claims.

### LIST OF REFERENCE NUMERALS

10 control device
14 air intake channel
18 exhaust gas recirculation channel
22 air intake channel central axis
26 seal
30 opening
34 valve seat
38 control element
42 pivot axis
46 pivot arm
50 pivot shaft
54 throttle flap
58 valve disk
62 screw
64 single-curved concave surface
66 gap
68 exhaust gas recirculation channel axis
70 even surface
74 single-curved concave surface

What is claimed is:

1-9. (canceled)

10: A control device for an internal combustion engine, the control device comprising:
an air intake channel;
an exhaust gas recirculation channel which is arranged to enter into the air intake channel, the exhaust gas recirculation channel comprising an opening at an end thereof;
a valve seat formed at the opening at the end of the exhaust gas recirculation channel; and
a valve disk which is configured to be placed on the valve seat via an actuator so that the opening of the exhaust gas recirculation channel can be closed, the valve disk being elastic,
wherein,
a plane spanned by at least one of the valve seat and by the valve disk forms an at least single-curved concave surface.

11: The control device as recited in claim 10, wherein,
the air intake channel comprises an air intake channel central axis, and
a curvature of the at least single-curved concave surface is parallel to the air intake channel central axis.

12: The control device as recited in claim 10, wherein,
the air intake channel comprises an air intake channel central axis, and
a curvature of the at least single-curved concave surface is orthogonal to the air intake channel central axis.

13: The control device as recited in claim 10, wherein the plane forms a double-curved concave surface.

14: The control device as recited in claim 10, wherein the valve disk is arranged in the air intake channel to be pivotable about a pivot axis.

15: The control device as recited in claim 10, wherein,
the exhaust gas recirculation channel comprises an exhaust gas recirculation axis, and
the valve disk is arranged in the air intake channel to be movable along the exhaust gas recirculation axis.

16: The control device as recited in claim 10, wherein the valve disk is made of sheet metal.

17: The control device as recited in claim 10, wherein,
the control device is spring-loaded so that the valve disk rests on the valve seat in a resting position of the control device in which the actuator is not activated, and
the valve disk comprises a spring force which is dimensioned so that at least one gap is formed between the valve disk and the valve seat in the resting position.

18: The control device as recited in claim 17, wherein the valve disk is pressed sealingly against the spring force by the actuator onto the valve seat in a closed position of the control device.
